(19) United States
(12) Patent Application Publication
(10) Pub. No.: US 2010/0250331 A1
(43) Pub. Date: Sep. 30, 2010

(54) EVALUATING THE QUALITY OF WEB-BASED PROPERTIES

(75) Inventors: Christo Devaraj, Seattle, WA (US); Guy Dassa, New Rochelle, NY (US); Harish Sanjeevi Krishnan, Redmond, WA (US); Rishi Bal, Bellevue, WA (US); Georgy Trifonov, Bellevue, WA (US); Jingyi Xu, Beijing (CN)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/413,870

(22) Filed: Mar. 30, 2009

(51) Int. Cl. G06Q 30/00; G06Q 10/00

(52) U.S. Cl. 705/10; 705/14.41

(57) ABSTRACT

Methods, systems, and media are provided for evaluating the quality of web-based properties for use as hosts of advertisements. Properties are automatically and dynamically evaluated for appropriateness of content, for instance, based upon extracted keywords and/or contextual information categories. Upon submission of an advertisement request, properties determined to be of insufficient quality are served a neutral advertisement, served a message indicating that no advertisement will be served, or served nothing at all. Advertisements determined upon submission of an advertisement request to be of sufficient quality are served one or more non-neutral advertisements as requested.

### BACKGROUND

Advertisements on web-based properties generate significant revenue, both for advertisers and for the web-based properties that host the advertisements. When an advertiser considers publishing advertisements on one or more web-based properties, the advertiser is concerned with the nature and quality of the site on which its advertisements are to be presented. Currently, a large number of advertisement publishing services either fail to adequately evaluate the web-based properties they serve with advertisements or they evaluate advertisements through manual checks by users. Inadequate evaluation leaves advertisers open to having their advertisements displayed on poor-quality web-based properties, while the practice of manual checking web-based properties is costly, time consuming and inefficient.

### SUMMARY

Embodiments of the present invention relate to systems and methods for utilizing information pertaining to web-based properties that request one or more advertisements to be served and presented in association therewith. The information takes the form of one or more quality-indicating data items and is used to evaluate the appropriateness of a requesting web-based property to host one or more advertisements, that is, to evaluate the quality of the web-based property. Web-based properties that are determined to meet threshold requirements for hosting one or more advertisements (i.e., that are determined to be of sufficiently high quality) are served one or more advertisements in response to an advertisement request. Web-based properties that are determined to not meet the threshold requirements to host one or more advertisements (i.e., that are determined to be of low quality) may be served a neutral advertisement, served a message indicating that an advertisement will not be served, or are simply not served anything in response to an advertisement request.

Embodiments of the invention are defined by the claims below, not this Summary. A high-level overview of various aspects of the invention is provided here for that reason, to provide an overview of the disclosure, and to introduce a selection of concepts that are further described below in the Detailed Description. This Summary is not intended to identify key features or essential features of the claimed subject matter, nor is it intended to be used as an aid in isolation to determine the scope of the claimed subject matter.

### BRIEF DESCRIPTION OF THE SEVERAL VIEWS OF THE DRAWINGS

Illustrative embodiments of the present invention are described in detail below with reference to the attached drawing figures, wherein:

FIG. 1 is a block diagram of an exemplary computing environment suitable for implementing embodiments of the present invention;

FIG. 2 is a schematic diagram showing an exemplary computing system architecture suitable for utilizing quality-indicating information pertaining to one or more web-based properties, in accordance with an embodiment of the present invention;

FIG. 3 is an expanded schematic diagram showing an exemplary computing system architecture suitable for utilizing quality-indicating information pertaining to one or more web-based properties, in accordance with an embodiment of the present invention;

FIG. 4 is a flow diagram showing a method for evaluating the quality of web-based properties in response to receiving an advertisement request, in accordance with an embodiment of the present invention;

FIG. 5 is a flow diagram showing a method for evaluating the quality of web-based properties in response to receiving an advertisement request, in accordance with an embodiment of the present invention;

FIG. 6 is a flow diagram showing a method for evaluating the quality of web-based properties, in accordance with an embodiment of the present invention;

FIG. 7 is a flow diagram showing another method for evaluating the quality of web-based properties, in accordance with an embodiment of the present invention; and

FIG. 8 is a flow diagram showing a further method for evaluating the quality web-based properties, in accordance with an embodiment of the present invention.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems and methods for utilizing quality-indicating information pertaining to one or more web-based properties that request service of advertisements to be presented in association therewith. The quality-indicating information is used to evaluate the appropriateness of the web-based property to host one or more advertisements associated with an advertiser, that is, to evaluate the quality of the web-based property requesting to host one or more advertisements. Web-based properties that are determined to meet the threshold requirements for hosting one or more advertisements (i.e., that are determined to be of sufficiently high quality) are served the one or more advertisements in response to an advertisement request.

In one embodiment, the present invention provides one or more computer-readable media having computer-executable instructions embodied thereon that, when executed by a computing device, perform a method for evaluating the quality of web-based properties. The method includes receiving an advertisement request from a web-based property, wherein the web-based property is associated with an identifier; crawling the web-based property to determine at least one quality-indicating data item; assigning or modifying a quality score based on the at least one quality-indicating data item; and storing the quality score and the web-based property identifier in association with one another.

In another embodiment, the present invention provides a computer-implemented method that, when executed by a computing device, evaluates web-based properties. The method includes receiving an advertisement request from a web-based property, wherein the web-based property is associated with an identifier; determining, utilizing a first computing process, that a quality score has been assigned to the web-based property; serving an advertisement based on the quality score assigned to the web-based property; determining, utilizing a second computing process, that the quality score assigned to the web-based property is invalid; modifying the quality score assigned to the web-based property; determining, utilizing a third computing process, that the served advertisement is to be changed based on the modified quality score assigned to the web-based property; and serving a different advertisement to the web-based property.

A further embodiment of the invention provides one or more computer-readable media having computer-executable instructions embodied thereon that, when executed by a computing device, perform a method for evaluating the quality of web-based properties. The method includes receiving an advertisement request from a web-based property, wherein the web-based property is associated with an identifier; determining that at least one quality score and at least one contextual information category have been assigned to the web-based property; serving an advertisement based on the quality score and contextual information category assigned to the web-based property; determining that at least one of the quality score and at least one contextual information category assigned to the web-based property fails to meet threshold requirements for the web-based property to be eligible to receive advertisements; modifying the at least one of the quality score and the at least one contextual information category that fails to meet the threshold requirements; determining that the served advertisement is to be changed based on the modified at least one of the quality score and the at least one contextual information category assigned to the web-based property; and serving a different advertisement to the web-based property in response to a subsequent advertisement request.

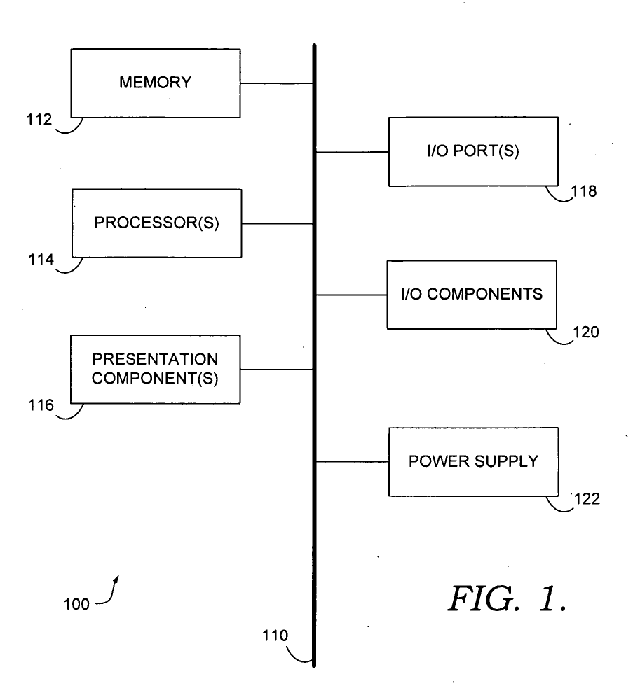

Having briefly described an overview of embodiments of the present invention, an exemplary operating environment in which various aspects of the present invention may be implemented is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. It is recognized that such is the nature of the art, and reiterated that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100.

Memory 112 includes computer-storage media in the form of volatile and/or non-volatile memory. The memory may be removable, non-removable, or a combination thereof. Exemplary hardware devices include solid-state memory, hard drives, optical-disc drives, etc. Computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

I/O ports 118 allow the computing device 100 to be logically coupled to other devices including the I/O components 120, some of which may be built in. Illustrative components include a microphone, joystick, game pad, satellite dish, scanner, printer, wireless device, and the like.

Embodiments of the present invention relate to systems and methods for utilizing quality-indicating information pertaining to one or more web-based properties that request service of advertisements for presentation in association therewith. The quality-indicating information is used to evaluate the appropriateness of the web-based property to host one or more advertisements associated with an advertiser, that is, to evaluate the quality of the requesting web-based property. Web-based properties that are determined to meet the threshold requirements for hosting one or more advertisements (that is, that are determined to be of sufficiently high quality) are served the one or more advertisements in response to an advertisement request.

In embodiments, the quality-indicating information that may be used in the evaluation of a web-based property may be obtained by extracting keywords from the web-based property and/or extracting contextual information from the web-based property, wherein contextual information comprises at least one of content filtering information, page context information, and a sensitivity score. The number of content filtering categories may number at least 12-15. Examples of content filtering categories may include, by way of example only, gambling, explicit word use, and the like. The number of page categories, also known as pure categories, may number at least 2,300 which allows for much greater specificity of web content. Examples of page categories may include, by way of example only, cooking, biking, celebrities, and the like. The sensitivity score may be based on the overall impression of the web-based property.

The quality-indicating data item(s) gathered by the crawl of the web-based property need not only be used in determining a quality score to assign to the web-based property. The contextual information may also be used to assign one or more categories to the web-based property that may then be used to further filter the type of advertisement that may be used for a given advertiser. Moreover, as the nature of the web-based property changes, the contextual information categories may be updated to ensure that advertisers are targeting desired demographic audiences directed to their advertisement.

Based upon the quality-indicating information obtained from a web-based property, the web-based property may be assigned a quality score, the value of which determines whether or not the web-based property is of sufficiently high quality to receive one or more advertisements in response to an advertisement request. The quality score may then be stored in associating with the web-based property, or an indicator thereof, for reference upon receiving future advertisement requests. If upon receipt of an advertisement request, it is determined that the requesting web-based property has no prior quality score by which to determine whether the web-based property is of sufficiently high quality to receive an advertisement in response to the request, such as when the web-based property sends an advertisement request for the very first time, then the web-based property may be served a neutral advertisement in response to the advertisement request, at least until such time as a quality score is determined.

Embodiments of the present invention are directed towards methods, systems and medium for providing improved evaluation of the quality of internet web-based properties. A “web-based property” is a webpage that is associated with a publisher of web content and is generally identified by a Uniform Resource Locator (URL). In some embodiments, the present invention allows advertising publishers to evaluate the suitability of web-based properties that subscribe to a particular advertising publisher service.

Generally, advertisers post advertisements in an effort to increase exposure and, accordingly, potential customers. The quality or suitability of web-based properties that host their advertisements is important to an advertiser, in part, to ensure that their advertisements are not hosted on web-based properties that may harm the advertiser's image. For instance, an advertiser might face public backlash, and consequently lower sales, if their advertisements were associated with a web-based property containing vulgar words or images. In an effort to alleviate the potential for advertisers to be associated with negative content on web-based properties, embodiments of the current invention provide a process for automatic and dynamic evaluation of the quality or propriety of web-based properties on which advertisers may wish to have their advertisements posted. In this regard, “automatic” is construed as meaning “without user intervention.”

In embodiments of the present invention, web-based properties are assigned a quality score based on information (that is, quality-indicating data items) gathered during a crawl of the web-based property. The information obtained from crawling a web-based property may include keywords extracted from the web-based property and contextual information extracted from the web-based property. Each of the keywords and the contextual information may be considered “quality-indicating data items.” Contextual information may comprise content filtering information, page context information, and/or one or more sensitivity scores. In some embodiments, the contextual information associated with a web-based property identifier, such as a URL, may be stored in a delivery engine, wherein the delivery engine is a repository for advertisements and data items related to advertisement publishing.

At least one of the keywords and contextual information gathered during crawling of a web-based property may be delivered to a front end service. The front end service may then send the keywords and/or contextual information to an online store, wherein the keywords and/or contextual information may be analyzed to determine a quality score. The quality score, in turn, may be utilized to indicate the extent to which the web-based property meets the requirements set by advertisers for a web-based property that may host an advertisement from the advertisers. In one embodiment, a quality score determination may comprise evaluating the keywords and/or contextual information received from crawling the web-based property to assign at least one of a content filtering category, a page context category and/or a sensitivity score to the web-based property. To determine whether a web-based property meets the requirements of advertisers to receive advertisements, the quality score assigned to the web-based property may be compared against a threshold quality score that may be set, for instance, by the advertiser or the advertisement publisher. If the quality score assigned to the web-based property meets or exceeds the threshold quality score, the web-based property may be eligible to receive advertisements, that is, the web-based property may be considered to be of sufficiently high quality to receive advertisements. If the web-based property fails to meet the threshold quality score, the web-based property may be ineligible to receive advertisements, that is, the web-based property may be considered to be of insufficient quality to receive advertisements.

In embodiments of the present invention, a web-based property sends a request for an advertisement. Based on the availability of a quality score assigned to the web-based property, the advertising publisher service will either send a neutral advertisement, send an advertiser-sponsored advertisement, or remove the web-based property from the listings of the advertisement publisher service. In alternative embodiments, a quality score may be considered unavailable if it is based on an assessment of the web-based property that is not current, e.g., if the assessment has not occurred within a pre-determined amount of time prior to the advertisement request.

The quality score assigned to the web-based property may be assigned or modified based on a quality evaluation that may be performed in response to the web-based property's submission of an advertisement request. The quality evaluation may be performed by crawling the web-based property for certain identifiers of inappropriate content. In addition to the quality score determined from a web crawl, a separate quality score may be determined and maintained by a network used to access the web-based property. Due to a quality score assigned by a network, a user may not be able to access a web-based property if the network has determined that the web-based property fails to meet the network's quality standards.

While some embodiments of the present invention may discuss a quality score as being a quantitative amount, such as a number, other embodiments may use a quality score that is a tuple of factors, wherein the tuple of factors may be combined into one assessment. For example, the quality score may comprise a data structure holding information related to a number of quality-indicating factors. While an analytical model may be run on top of the data structure, outputting a single number as a result, the quality score may comprise multiple outputs and/or dimensions.

In one embodiment, if a quality evaluation has not been completed prior to receipt of an advertisement request from the web-based property, for example when the web-based property submits an advertisement request to a particular advertisement publisher service for the very first time, then the advertisement publisher service may provide an advertisement that comprises neutral content, such as “Go Green,” or “Be Sure to Recycle!,” or any other neutral advertisement that, for instance, does not reference the advertisement publisher service or any clients of the advertiser publisher service. In an alternative embodiment, a web-based property may be crawled when it first subscribes to an advertising publisher service. In this embodiment, the web-based property may have an assigned quality score before the receipt of an advertisement request. In another alternative, a web-based property may be eligible for a randomized crawl upon its subscription to an advertising publisher service. In this embodiment, the web-based property may also have an assigned quality score before the receipt of an advertisement request.

In further embodiments, a crawl of the web-based property may be conducted after the advertisement request has been received and prior to the delivery of an advertisement. In this embodiment, the results from the web crawl may be analyzed and produce a quality score within the short time period of time prior to the serving of an advertisement to the web-based property. Alternatively, a quality score may be produced based on a limited number of results from the web crawl, wherein the factors are able to be determinative within the short amount of time that may occur between an advertisement request and the delivery of an advertisement to the web-based property. Any and all such variations, and any combination thereof, are contemplated to be within the scope of embodiments of the present invention.

If a quality score is associated with the web-based property, the advertisement publisher service may take one of two actions upon receipt of an advertisement request from the web-based property. If the web-based property is found to meet or exceed threshold requirements for suitability (that is, to be of sufficiently high quality), a sponsored advertisement may be served to the web-based property in response to the advertisement request. If, however, the web-based property fails to meet threshold requirements for suitability, the web-based property may be removed from a listing of quality web-based properties on the advertisement publisher service. It will be understood and appreciated by those of ordinary skill in the art that advertisements served to the web-based property may originate from another source, such as a non-profit organization or the parent company of the advertisement publisher service. Any and all such variations, and any combination thereof, are contemplated to be within the scope of embodiments of the present invention.

In addition to evaluating a web-based property in response to an advertisement request, a web-based property may also be evaluated on one or more of a periodic, random and/or continuous basis in order to ensure that the quality score assigned to a web-based property is still applicable even when content associated with the web-based property may have changed over time. Web content on web-based properties generally changes over time. In embodiments, if a web-based property possesses a quality score that is found to meet the threshold requirements for suitability but is near, or is found to progressively edge lower toward, the minimum threshold of de-listing, then the web-based property may be marked for a greater number of quality evaluations than a web-based property that possesses a score that exceeds the threshold by a significant amount. Any and all such variations, and any combination thereof, are contemplated to be within the scope of embodiments hereof.

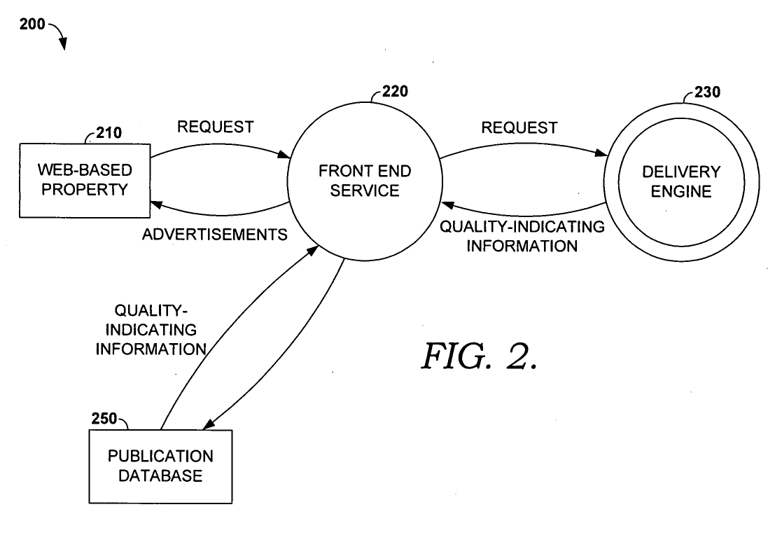

Turning now to FIG. 2, a schematic diagram is illustrated showing an exemplary computing system architecture 200 suitable for utilizing quality information (e.g., quality-indicating data items) pertaining to one or more web-based properties to determine whether to serve an advertisement in response to a request, in accordance with an embodiment of the present invention. The computing system architecture 200 includes a web-based property 210, a front end service 220, an information delivery engine 230 and a publication database 250. The web-based property 210 is communicatively coupled to the front end service 220. The front end service 220 is communicatively coupled to the delivery engine 230 and the publication database 250. The web-based property 210 includes one or more portions thereof designated as advertisement units, the advertisement units being locations on the web-based property where the publisher thereof desires to have one or more advertisements presented. In an attempt to receive an advertisement for presentation, a request for an advertisement is transmitted from the web-based property 210 to the front end service 220.

The front end service 220 is configured to receive the advertisement request from the web-based property and determine whether the web-based property is of sufficiently high quality to receive the requested advertisement. In the latter regard, the front end service 220 queries the publication database 250 to determine whether or not the web-based property already has a quality score associated therewith. If the web-based property has previously submitted an advertisement request to the front end service 220, a quality score will be associated therewith. However, if no prior requests have been received by the front end service 220 from the web-based property 210, no quality score will yet be associated with the requesting web-based property 210. Indicators of web-based properties (e.g., URLs) and their associated quality scores are stored in association with the publication database 250. In embodiments, the publication database 250 may store additional information, e.g., extracted keywords, content categories, and the like. Advertisements may also be stored in association with the publication database 250, if desired. Any and all such variations, and any combination thereof, are contemplated to be within the scope of embodiments of the present invention. In response to the query, the publication database 250 returns the requested information to the front end service 220.

If the information returned from the publication database 250 indicates that the requesting web-based property 210 does have a quality score associated therewith, the front end service 220 analyzes the score (and other returned information, if desired) to determine if the web-based property is of sufficient quality to receive the requested advertisement. If the web-based property 210 is determined to be of insufficient quality to receive the requested advertisement, the front end service 220 may return a message indicating that no advertisement will be served, may return a neutral advertisement, or may simply not return anything in response to the request. If, however, it is determined that the requesting web-based property 210 is of sufficiently high quality to receive the requested advertisement, the front end service 220 returns the requested advertisement for presentation in association with the web-based property 210. Advertisements may be stored in association with the front end service 220, the publication database 250, or any other database (not shown) that is accessible by the front end service 220.

Alternatively, if the information returned indicates that the web-based property 210 does not have a quality score associated therewith, the front end service 220 may serve a neutral advertisement, such as “Go Green,” or “Be Sure to Recycle!,” or any other neutral advertisement that, for instance, does not reference the advertisement publisher service or any clients of the advertiser publisher service, until such time as a quality score is determined. In another embodiment, the front end service 220 may return a message indicating that no advertisement will be served. In yet another embodiment, the front end service 220 may not serve anything until a score is determined. Any and all such variations, and any combination thereof, are contemplated to be within the scope of embodiments hereof.

If the requesting web-based property 210 does not have a quality score associated therewith, the front end service 220 is configured to initiate a crawl to assess the propriety of a web-based property 210 before returning a neutral message, advertisement or other response to the advertisement request. In embodiments, the crawl initiated by the front end service 220 is performed by the delivery engine 230. After a crawl of a web-based property 210 has been completed, the front end service 220 is configured to receive quality information about the web-based property 210, for instance, a quality score, content filtering information, page context information and extracted keyword information from the delivery engine 230. The front end service 220 analyzes the received information to determine if the web-based property 210 is of sufficiently high quality to receive the requested advertisement. If the web-based property 210 is determined to be of insufficient quality to receive the requested advertisement, the front end service 220 may return a message indicating that no advertisement will be served, may return a neutral advertisement, or may simply not return anything in response to the request. If, however, it is determined that the requesting web-based property 210 is of sufficient quality to receive the requested advertisement, the front end service 220 is configured to return the requested advertisement for presentation in association with the web-based property 210 . As previously stated, advertisements may be stored in association with the front end service 220, the publication database 250, or any other database (not shown) that is accessible by the front end service 220. The front end service 220 is further configured to transmit the information received from the crawl (e.g., from the delivery engine 230) to the publication database 250) for storage in association therewith.

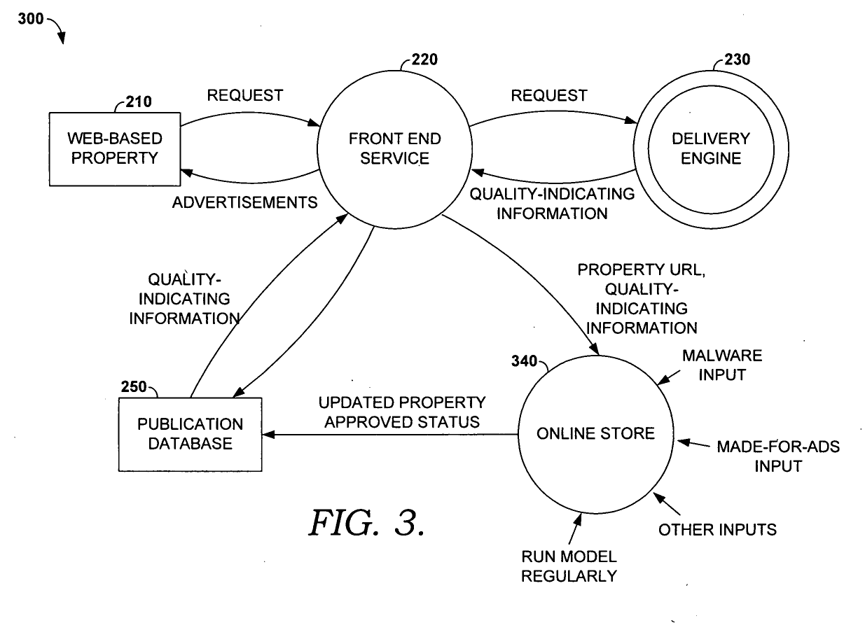

Turning now to FIG. 3, an expanded schematic diagram showing an exemplary computing system architecture 300 suitable for utilizing quality-indicating information pertaining to one or more web-based properties to determine whether to serve an advertisement in response to a request, in accordance with an embodiment of the present invention. The computing system architecture 300 includes the web-based property 210, the front end service 220, the information delivery engine 230, and the publication database 250 discussed hereinabove with reference to FIG. 2. The computing system architecture 300 further includes an online store 340 communicatively coupled to the front end service 220 and the publication database 250.

As discussed in FIG. 2, the front end service 220 is configured to receive advertisement requests from the web-based property 210 and determine whether a quality score has been associated with the requesting web-based property 210. If the web-based property 210 is determined to have a sufficiently high quality score associated therewith, the front end service is configured to serve the requested advertisement to the web-based property 210, as discussed with reference to FIG. 2. The front end service 220 is further configured to determine whether the quality score associated with the web-based property is still eligible to be used to assess a web-based property's appropriateness to receive advertisements in response to an advertisement request. In this regard, the front end service 220 is configured to transmit an identifier of the requesting web-based property (e.g., the URL) and the quality-indicating information received from the publication database 250 to the online store 340.

The online store 340 is configured to receive the quality-indicating information associated with the web-based property 210 and to determine if there is any additional quality-indicating information available about the web-based property 210 that would be useful in evaluating the propriety of the web-based property 210. In this regard, the online store 340 is configured to draw on a number of resources including, by way of example only, malware input and made-for-ads input, to determine if there is any additional quality-indicating information related to the web-based property 210. In embodiments, the online store 340 may search for information about the publisher of the web-based property as well as for the web-based property 210 itself.

Once the online store 340 compiles quality-indicating information from the queried resources, newly discovered quality-indicating information is transmitted to the publication database 250 for storage in association therewith. Such newly discovered quality-indicating information may include, but is not limited to, category data, keyword data, a quality score and/or crawl frequency data. The newly discovered quality-indicating information may then be transmitted to the front end service 220 where the front end service 220 may determine whether the web-based property is still suitable to host an advertisement. If the assessment at the front end service 220 determines that the web-based property is still suitable to host an advertisement and an advertisement has already been served, no further action is taken. If the assessment at the front end service 220 determines that the web-based property is no longer suitable to host an advertisement and an advertisement has already been served (based on the previous quality-indicating information), the web-based property may be removed from the publication database 250.

If the assessment at the front end service 220 determines that the web-based property is still suitable to host an advertisement and an advertisement has not already been served, the front end service 220 may deliver an advertisement to the web-based property 210. If the assessment at the front end service 220 determines that the web-based property is no longer suitable to host an advertisement and an advertisement has not already been served, a neutral advertisement or message may be served, or no further action may be taken.

It should be noted that, in embodiments, the front end service 220 may be configured to run quality checks on web-based properties having information stored in association with the publication database 250 at any desired interval and not only in response to an advertisement request. Such quality checks may be initiated upon the front end service 220 transmitting a webpage indicator (e.g., URL) and associated quality-indicating information to the online store 340, as desired.

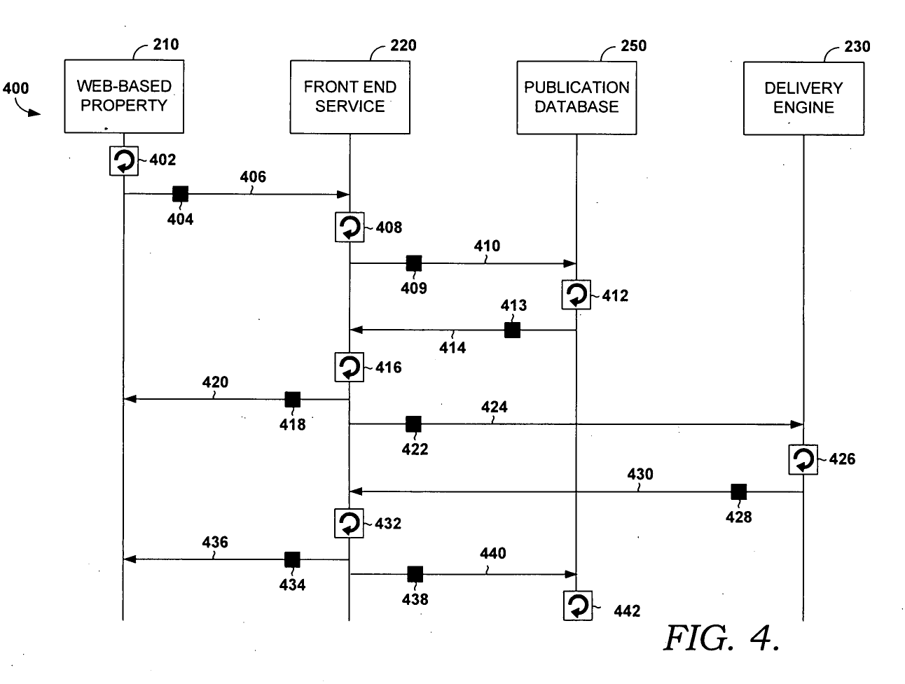

With reference now to FIG. 4, a flow diagram is illustrated showing a method 400 for evaluating web-based properties in response to receiving an advertisement request from a web-based property 210 not listed in the publication database 250, in accordance with embodiments of the present invention. Initially, as indicated at block 402, a web-based property 210 generates an advertisement request 404, evidencing a desire to have an advertisement presented in association with one or more ad units associated therewith. The advertisement request 404 is the sent 406 to the front end service 220 where it is evaluated 408. At block 408, the front end service 220 generates a database query 409 which is sent 410 to the publication database 250 to determine whether the web-based property 210 is listed in the publication database 250. At block 412, the publication database 250 accesses information that the web-based property 250 is not listed in the publication database 250 and generates a response 413 to the database query 409. The response 413 is then sent 414 to the front end service 220.

The front end service 220 receives the response 413 and generates a neutral advertisement and/or message 418. The front end service 220 then delivers 420 the neutral advertisement or message 418 to the web-based property 410. The front end service 220 also generates a crawl request 422 that is sent 424 to the information delivery engine 230. At block 426, the delivery engine 230 crawls the web-based property associated 210, extracts quality-indicating information about the web-based property 210 and generates a response 428 that is then sent 430 to the front end service 220. The response 428 may include, by way of example only, Extensible Markup Language (XML) and information about the web-based property 210 including content filtering (CF) information, page content category information and sensitivity scores.

At the front end service 220, the response 430 from the delivery engine 230 is evaluated 432 to determine whether the web-based property 210 that generated the advertisement request 404 is suitable to host an advertisement. In embodiments, when the front end service 220 evaluates the requesting web-based property 210, keywords may be compared against a number of content filtering categories that may have been flagged as indicating undesirable web content. The extracted keywords may be compared against the content filtering categories to determine a quality score assignment for the web-based property 210. An alternative means of evaluation may be to use the keywords extracted from a web-based property 210 from the crawler to assign the web-based property 210 into one of a number of pure categories used to distinguish web pages. Another means of evaluation may be through the use or aid of a sensitivity score. Any and all such variations, and any combination thereof, are contemplated to be within the scope of embodiments of the present invention.

Still at step 432, the front end service 220 determines the web-based property 210 is suitable to host an advertisement and serves 436 an appropriate advertisement 434 to the web-based property 210. The appropriate advertisement 434 may be based on page content data or other data. The front end service 220 also sends 440 the response 428 from the delivery engine 230 to the publication database 250 where the information 428 is stored 442.

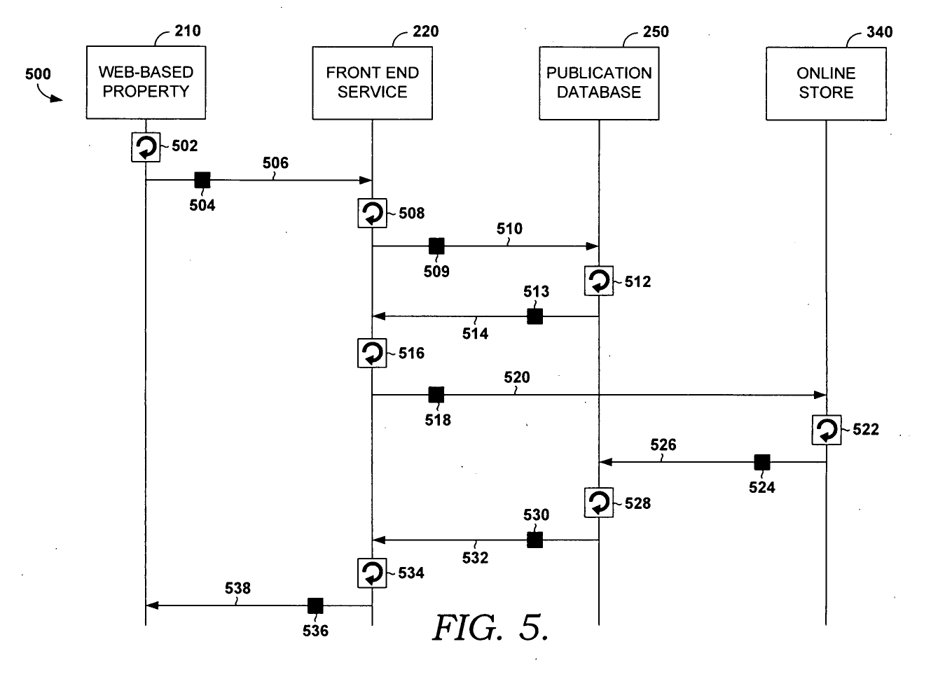

Turning now to FIG. 5, a flow diagram is illustrated showing a method 500 for evaluating web-based properties in response to receiving an advertisement request from a web-based property 210 that is listed in the publication database 250, in accordance with embodiments of the present invention. Initially, as indicated at block 502, a web-based property 210 generates an advertisement request 504 and sends 506 the request to the front end service 220 where it is evaluated 508. At block 508, the front end service 220 generates a database query 509 which is sent 510 to the publication database 250 to determine whether the web-based property 210 is listed in the publication database 250. At block 512, the publication database 250 accesses information that the web-based property 250 is listed in the publication database 250 and generates a response 513 to the database query 509. The response 513 is then sent 514 to the front end service 220.

The front end service 220 evaluates 516 the response 513 and generates an information request 518 to determine if there is additional quality-indicating information that pertains to the web-based property 210 that may be available. The information request 518 is sent to the online store 340.

At block 522, the online store 340 evaluates the information request 518 and determines that there is additional quality-indicating information available relating to the web-based property 210 associated with the advertisement request 504. The online store 340 generates a response 524 to the information request 518 and sends 526 the response 524 to the publication database 250 where the additional quality-indicating information is stored 528. A response 530 is sent 532 from the publication database 250 to the front end service 220, wherein the response 530 comprises the additional quality-indicating information related to the web-based property 210. At block 534, the front end service 534 evaluates the additional quality-indicating information received from the publication database 250 and determines the web-based property 210 is suitable for hosting an advertisement. Still at block 534, the front end service 220 serves 538 an appropriate advertisement 536 to the web-based property 210 for presentation in association therewith.

In another embodiment, the web-based property 210 may be found to not meet the threshold suitability standard required for the web-based property 210 to host advertisements. In this alternative, the front end service 220 may send a notification to the user that an advertisement will not be served to the web-based property 210. In addition or alternatively, the front end service 220 may remove the web-based property 210 from the publication database 250. In another alternative, the web-based property 210 may be kept in the publication database 250 as being on suspension, wherein no advertisements will be served to the web-based property 210 until at least one subsequent evaluation finds that the web-based property 210 meets the minimum threshold of suitability to host an advertisement. This shift between suspension and activation is especially possible with respect to web-based properties due to the generally fluid and changing nature of content on the internet. Any and all such variations, and any combination thereof, are contemplated to be within the scope of embodiments of the present invention.

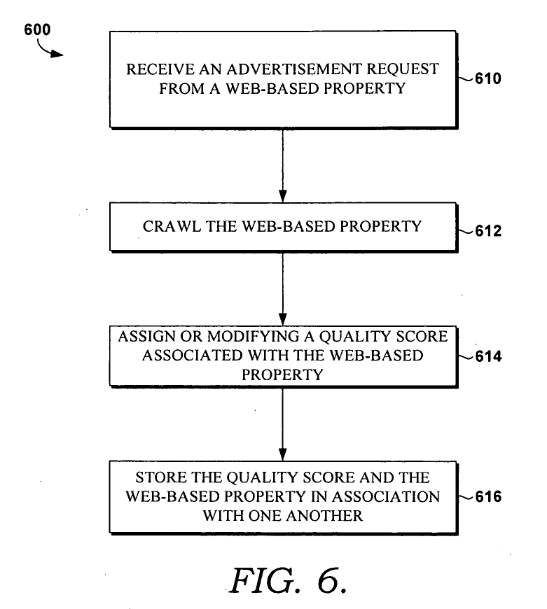

Turning now to FIG. 6, a flow diagram is illustrated showing a method 600 for evaluating the quality of web-based properties, in accordance with an embodiment of the present invention. As indicated at block 610, an advertisement request is received from a web-based property. The web-based property may be associated with a web identifier, such as a URL. As indicated at block 612, the web-based property is crawled to determine at least one quality-indicating data item (e.g., an extracted keyword, a contextual category, or the like). If a prior quality score is assigned to the web-based property, the prior quality score is modified based on the at least one quality-indicating data item. If, however, a prior quality score is not assigned to the web-based property, a quality score is assigned to the web-based property. This is indicated at block 614. The quality score (modified or newly assigned) is subsequently stored in association with the web page (or identifier thereof, as appropriate), as indicated at block 616.

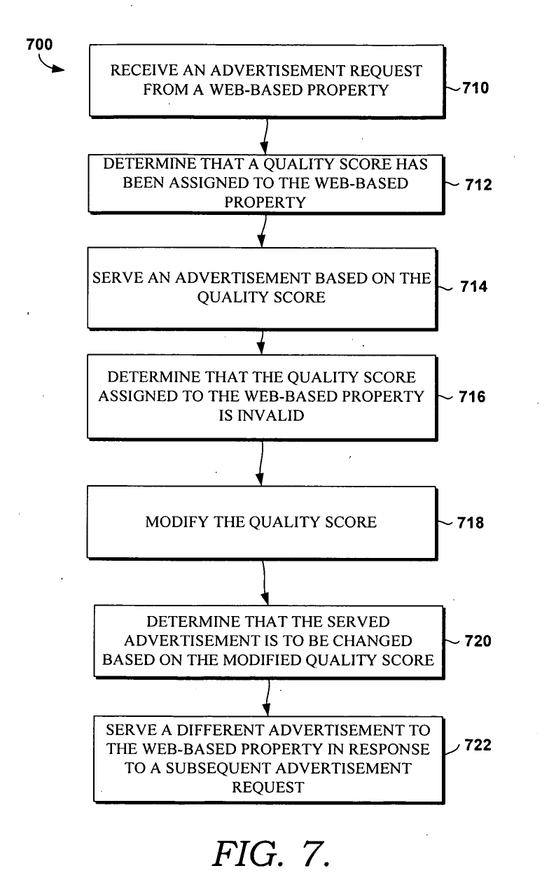

FIG. 7 is a flow diagram showing a method 700 for evaluating the quality of web-based properties, in accordance with an embodiment of the present invention. As indicated at block 710, an advertisement request is received from a web-based property. The web-based property may be associated with a web identifier, such as a URL. As indicated at block 712, a determination is made that a quality score has been assigned to the web-based property. As indicated at block 714, an advertisement is served to the web-based property based on the quality score assigned thereto. As indicated at block 716, a determination is made that the quality score assigned to the web-based property is invalid. In embodiments, this determination is made by comparing the quality score assigned prior to receipt of the advertising request to a new quality score calculated from keyword and contextual information retrieved from a crawl of the web-based property, the crawl being conducted in response to receiving the advertisement request. As indicated at block 718, the quality score is modified. As indicated at block 720, it is determined that the advertisement served (at block 714) is to be changed based upon the modified quality score. Finally, as indicated at block 722, a different advertisement is served to the web-based property in response to a subsequent advertisement request in accordance with the modified quality score.

At step 760, a determination is made as to whether the advertisement sent to the web-based property in response to the first advertisement request, the same advertisement that was based on the score that was assigned prior to the receipt of the first advertisement request, should be changed. There are instances, for example, where a score may change between web crawls, but wherein both scores share the common trait of meeting or exceeding the minimum threshold requirements for receiving advertisements. If this is the case, the score may not need to be changed. However, if the score calculated based from the latest web crawl fails to meet the minimum threshold for receiving advertisements, then another action may be taken, such as delivering a neutral advertisement in response to a subsequent advertisement request, wherein the neutral advertisement may not be linked to an advertiser or to the advertising publishing service.

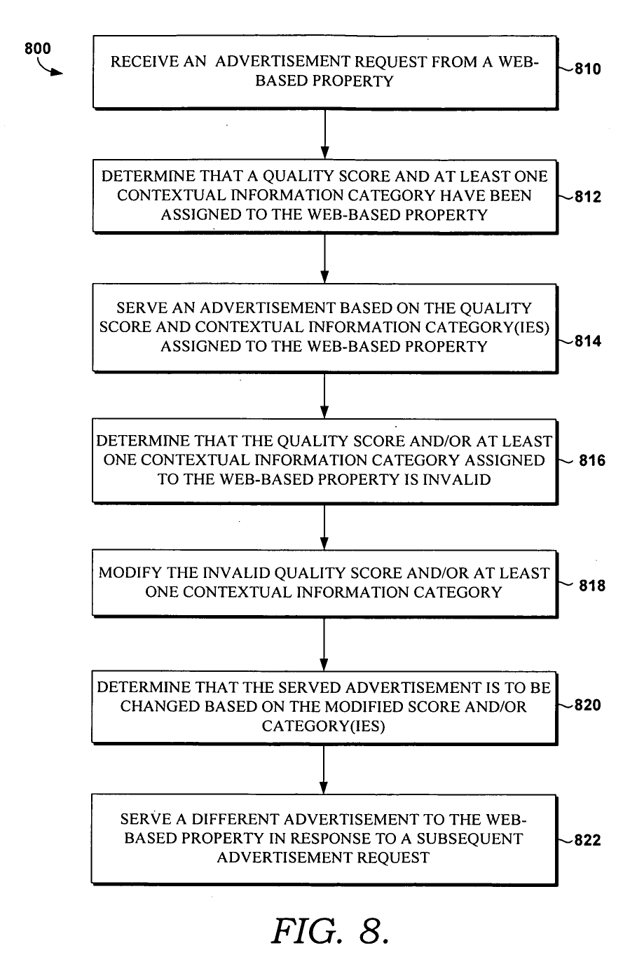

With reference now to FIG. 8, a flow diagram is illustrated showing a method 800 for evaluating the quality of web-based properties, in accordance with an embodiment of the present invention. As indicated at block 810, an advertisement request is received from a web-based property. The web-based property may be associated with a web identifier, such as a URL. As indicated at block 812, a determination is made whether a quality score and at least one contextual information category have been assigned to the web-based property. The quality score and the contextual information category(ies) may be assigned prior to the receipt of the advertisement request, given that the web-based property may be listed in the publication database of the advertiser publishing service prior to the receipt of the advertisement request (either due to prior received advertisement requests or random crawling that is not initiated by a received advertisement request). As indicated at block 814, an advertisement is served in response to the request. As previously set forth, the advertisement may be neutral or non-neutral, depending on the quality score and/or contextual information category(ies) determined.

As indicated at block 816, it is determined that at least one of the assigned quality score and the at least one contextual information category is not appropriate for use in evaluating the quality of the web-based property. As indicated at block 818, a modified quality score and/or contextual information category(ies) are determined. As indicated at block 820, it is next determined that the served (neutral or non-neutral) advertisement is to be changed. In one embodiment, a quality score may be changed from being of sufficient quality to receive a non-neutral advertisement to being of insufficient quality and thus deserving of only a neutral advertisement. In another embodiment, the quality score may be changed from being of insufficient quality to receive a neutral advertisement to being deserving of a non-neutral advertisement. In yet another embodiment, the quality score may continue to meet the minimum requirements to receive a non-neutral advertisement but a contextual category of the web-based property may have changed from “gardening tips” to “heavy rock bands” necessitating an advertisement change to better reflect the desired demographic of the advertiser. Any and all such variations, and any combination thereof, are contemplated to be within the scope of embodiments of the present invention. As indicated at block 822, a different advertisement is accordingly served in response to a subsequent advertisement request.

Many different arrangements of the various components depicted, as well as components not shown, are possible without departing from the scope of the claims below. Embodiments of the subject technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable storage media having computer-executable instructions embodied thereon that, when executed by a computing device, perform a method for evaluating quality of web-based properties, the method comprising:
receiving an advertisement request from a web-based property, wherein the web-based property is associated with an identifier;
crawling the web-based property to determine at least one quality-indicating data item;
assigning or modifying a quality score based on the at least one quality-indicating data item; and
storing the quality score and the web-based property identifier in association with one another.

2. The one or more computer-readable media of claim 1, further comprising:
determining that the web-based property does not have a prior quality score assigned thereto; and
prior to crawling the web-based property, serving at least one of a neutral advertisement and a message indicating that no advertisement will be served in response to the advertisement request.

3. The one or more computer-readable media of claim 2, further comprising:
determining, based on the at least one quality-indicating data item, to serve a non-neutral advertisement; and
serving the non-neutral advertisement in response to a subsequent advertisement request.

4. The one or more computer-readable media of claim 2, further comprising:
determining, based on the at least one quality-indicating data item, not to serve a non-neutral advertisement; and
serving a message that no advertisement will be served in response to a subsequent advertisement request from the web-based property.

5. The one or more computer-readable media of claim 1, further comprising:
determining that the web-based property has a prior quality score assigned thereto,
wherein assigning or modifying the quality score based on the at least one quality-indicating data item comprises:
determining that the prior quality score is invalid; and
modifying the quality score,
and wherein storing the quality score and the web-based property identifier in association with one another comprises storing the modified quality score and the web-based property identifier in association with one another.

6. The one or more computer-readable media of claim 5, further comprising:
determining, based on the modified quality score, to serve a non-neutral advertisement; and
serving the non-neutral advertisement in response to the advertisement request.

7. The one or more computer-readable media of claim 5, further comprising:
determining, based on the modified quality score, not to serve a non-neutral advertisement; and
serving a message that no advertisement will be served.

8. The one or more computer-readable media of claim 1, wherein crawling the web-based property for at least one quality-indicating data item comprises at least one of extracting keywords from the web-based property and extracting contextual information from the web-based property, and wherein contextual information comprises at least one of content filtering information, page context information, and a prior quality score.

9. The one or more computer-readable media of claim 1, further comprising:
comparing the quality score against a pre-determined threshold; and
upon determining that the quality score meets or exceeds the pre-determined threshold, serving one or more non-neutral advertisements to the web-based property.

10. The one or more computer-readable media of claim 1, further comprising:
comparing the quality score against a pre-determined threshold; and
upon determining that the quality score fails to meet the pre-determined threshold, serving a message that no advertisement will be served.

11. A computer-implemented method that, when executed by a computing device, evaluates quality of web-based properties, the method comprising:
receiving an advertisement request from a web-based property, wherein the web-based property is associated with an identifier;
determining, utilizing a first computing process, that a quality score has been assigned to the web-based property;
serving an advertisement based on the quality score assigned to the web-based property;
determining, utilizing a second computing process, that the quality score assigned to the web-based property is invalid;
modifying the quality score assigned to the web-based property;
determining, utilizing a third computing process, that the served advertisement is to be changed based on the modified quality score assigned to the web-based property; and
serving a different advertisement to the web-based property in response to a subsequent advertisement request.

12. The method of claim 11, wherein determining that the quality score assigned to the web-based property is invalid comprises determining that the score assigned to the web-based property does not meet a pre-determined threshold.

13. The method of claim 11, wherein determining that the served advertisement is to be changed based on the modified quality score assigned to the web-based property comprises determining that a message indicating that no advertisement will be served is appropriate.

14. The method of claim 13, wherein serving a different advertisement to the web-based property in response to a subsequent advertisement request comprises receiving a subsequent advertisement request and serving the message.

15. The method of claim 11, wherein determining that the quality score assigned to the web-based property is invalid comprises crawling the web-based property and extracting at least one of keywords and contextual information from the web-based property, wherein contextual information comprises at least one of content filtering information, page context information, and a sensitivity score.

16. The method of claim 15, further comprising:
evaluating the at least one of keywords and contextual information to assign at least one of a content filtering category, a page context category and the modified quality score to the web-based property.

17. One or more computer-readable storage media having computer-executable instructions embodied thereon that, when executed by a computing device, perform a method for evaluating quality of web-based properties, the method comprising:
receiving an advertisement request from a web-based property, wherein the web-based property is associated with an identifier;
determining that a quality score and at least one contextual information category have been assigned to the web-based property;
serving an advertisement based on the quality score and contextual information category assigned to the web-based property;
determining that the at least one of quality score and at least one contextual information category assigned to the web-based property is invalid;
modifying the at least one of the quality score and the at least one contextual information category that is invalid;
determining that the served advertisement is to be changed based on the modified at least one of the quality score and the at least one contextual information category assigned to the web-based property; and
serving a different advertisement to the web-based property in response to a subsequent advertisement request.

18. The one or more computer-readable media of claim 17, wherein determining that the at least one of the quality score and at least one contextual information category assigned to the web-based property is invalid comprises determining that the quality score assigned to eth web-based property is invalid, and wherein determining that the quality score assigned to the web-based property is invalid comprises determining that the quality score assigned to the web-based property does not meet a pre-determined threshold.

19. The one or more computer-readable media of claim 17, wherein determining that the served advertisement is to be changed based on the modified quality score assigned to the web-based property comprises determining that a message indicating that no advertisement will be served is appropriate.

20. The one or more computer-readable media of claim 19, wherein serving a different advertisement to the web-based property in response to a subsequent advertisement request receiving a subsequent advertisement request and serving the message.
